(19) United States
(12) Patent Application Publication
(10) Pub. No.: US 2009/0216922 A1
(43) Pub. Date: Aug. 27, 2009

(54) USB Driver Apparatus, USB External Apparatus, USB System Having the Same and USB Connect Apparatus Using Light Guide

(76) Inventors: Hyo Hoon Park, Yuseong-Gu (KR); Tae Woo Lee, Jung-Gu (KR); Do Won Kim, Yuseong-Gu (KR); Seong Won Kim, Gyeryong (KR)

Correspondence Address: WELLS ST. JOHN P.S., 601 W. FIRST AVENUE, SUITE 1300, SPOKANE, WA, 99201, US

(21) Appl. No.: 12/344,387

(22) Filed: Dec. 26, 2008

(30) Foreign Application Priority Data
Feb. 26, 2008 (KR) 10-2008-0017415
Apr. 16, 2008 (KR) 10-2008-0035344

(51) Int. Cl. G06F 13/12

(52) U.S. Cl. 710/63

(57) ABSTRACT

Provided are a USB driver apparatus using an optical waveguide, a USB external apparatus connected to the same, and a USB system and a USB connection apparatus including the same. The USB driver apparatus includes an optical USB port connected to the USB terminal of the external apparatus and configured to exchange data with the USB terminal using an optical signal; a USB interface part configured to input and output data through the optical USB port; and a photoelectric converter connected between the optical USB port and the USB interface part and configured to convert an optical signal into an electrical signal and vice versa, wherein the optical USB port and the photoelectric converter are connected to each other through the optical waveguide to transmit data as an optical signal. Therefore, it is possible to largely increase a data transmission speed of the USB system.

### BACKGROUND

1. Field of the Invention

The present invention relates, in general, to a USB driver apparatus using an optical waveguide, a USB external apparatus connected to the same, and a USB system and a USB connection apparatus including the same, and more particularly, to a USB driver apparatus using an optical waveguide, a USB external apparatus connected to the same, and a USB system and a USB connection apparatus including the same, in which data are transmitted between the USB driver apparatus and the USB external apparatus through the optical waveguide to enable high speed data transmission.

2. Description of the Related Art

In general, while a microprocessor unit (MPU) of a computer operates at a high speed of several GHz, data transmission through electrical interconnections around the MPU is slower. This slows the overall data processing speed of the system.

In particular, while the quantity of data processed between computers and peripheral devices is rapidly increasing, there is a limit to increasing transmission speed through conventional electrical connections. Thus, the problem of transmission speed through electrical interconnections is becoming more serious.

In order to solve this problem, instead of conventional data transmission through electrical interconnections, an optical connection for transmitting data as optical signals using an optical waveguide has been proposed. Since the USB system widely used to connect peripheral devices to a computer has only two signal transmission interconnections, the interconnections can be readily replaced with optical waveguides.

FIG. 1 is a plan view of a conventional USB system for transmitting data using electrical interconnections. As shown in FIG. 1, the conventional USB system includes a USB driver apparatus 100 including an I/O device 110 and a USB port 120 on a motherboard M of a host computer; and a USB external apparatus 160 (for example, a USB memory) including a USB terminal 130, a USB interface IC circuit 140, and a memory chip 150.

The I/O device 110 and the USB port 120 of the USB driver apparatus 100 are connected via two signal transmission electrical interconnections 170 separated into transmission and reception interconnections. In general, the I/O device 110 includes a circuit 180 having a USB driver function, and the I/O device 110 is, for example, included in a bridge chip-set or integrated in the vicinity.

The USB external apparatus 160 has the interconnection 170, an end of which is exposed to the USB terminal 130 which is inserted into the USB port 120 to be electrically connected thereto.

Meanwhile, FIG. 2 is a plan view of a USB system adopting a conventional optical connection. Conventional USB systems that adopt optical connections like that shown in FIG. 2 are disclosed in Korean Patent Registration No. 364251, entitled “Universal Serial Bus Connecting Apparatus”, Korean Patent Registration No. 405023, entitled “Optical Communication Interface Module for Universal Serial Bus”, and so on.

Korean Patent Registration No. 364251 describes technology in which a USB driver apparatus 200 and a USB external apparatus 280, for example, a USB memory, and so on, of a host computer are connected using an optical transmission/reception module and an optical waveguide such as an optical fiber. Two different optical transmission/reception modules 220 and 220′ including a photoelectric converter 210 and 210′ for converting an electrical signal into an optical signal or an optical signal into an electrical signal are connected via two optical fibers 230 for transmitting or receiving data. In addition, the optical transmission/reception modules 220 and 220′ and the optical fiber 230 are installed between the USB port 240 of the computer and the USB terminal 250 of the peripheral device.

Since the USB driver apparatus 200 and the USB external apparatus 280 use a transmission method using the conventional electrical interconnection of FIG. 1, the USB port 240 connected to the motherboard M of the computer uses a conventional electrical connection port without modification.

The USB terminal 260 of a first optical transmission/reception module 220 mounted in the USB port 240 of the motherboard M of the computer is exposed to the electrical interconnection 270. Electrical connections 270′ are connected to a USB port 290 of a second optical transmission/reception module 220′, to which the peripheral device, i.e., the USB external apparatus 280, is connected, and to the USB port 250 of the USB external apparatus 280 connected to the USB port 290, respectively.

In addition, Korean Patent Registration No. 405023 discloses a structure in which bidirectional optical transmission is accomplished through a single optical fiber between two modules using an optical coupler and an optical distributor in an optical transmission module. This apparatus also uses the conventional electrical connection port of the USB port connected to the motherboard of the computer without modification.

### SUMMARY

As described above, when a USB port and a USB terminal for conventional electrical connection are used without modification, an electrical interconnection still remains between a bridge chip-set and a USB port of a computer board to cause problems of speed limitation and high power consumption.

In order to overcome the above problems occurring in the related art, an object of the present invention is to provide a USB driver apparatus using an optical waveguide, a USB external apparatus connected to the same, and a USB system including the same that are capable of transmitting data between a USB port and a first USB interface part included in the USB driver apparatus and between a USB terminal and a second USB interface part included in the USB external apparatus as an optical signal using the optical waveguide, and transmitting data between the USB driver apparatus and the USB external apparatus as an optical signal to transmit the data at a high speed.

Another object of the present invention is to provide a USB connection apparatus using an optical waveguide that is capable of connecting two different USB driver apparatuses through the optical waveguide to transmit data at a high speed as an optical signal.

In order to achieve the above object, according to a first aspect of the present invention, there is provided a USB driver apparatus of a host computer for exchanging data with an external apparatus having a USB terminal, the USB driver apparatus including: an optical USB port connected to the USB terminal of the external apparatus and configured to exchange data with the USB terminal using an optical signal; a USB interface part configured to input and output data through the optical USB port; and a photoelectric converter connected between the optical USB port and the USB interface part and configured to convert an optical signal into an electrical signal and vice versa, wherein the optical USB port and the photoelectric converter are connected to each other through the optical waveguide to transmit data as an optical signal.

Here, the optical waveguide may be formed of an optical fiber or a polymer optical waveguide film.

The optical waveguide may be installed in a printed circuit board or stacked on the printed circuit board.

According to a second aspect of the present invention, there is provided a USB external apparatus for exchanging data with a USB driver apparatus of a terminal having a USB port, the USB external apparatus including: an optical USB terminal connected to the USB port of the terminal and configured to exchange data with the USB port using an optical signal; a USB interface part configured to input and output data through the optical USB terminal; and a photoelectric converter connected between the optical USB terminal and the USB interface part and configured to convert an optical signal into an electrical signal and vice versa, wherein the optical USB terminal and the photoelectric converter are connected to each other through the optical waveguide to transmit data as an optical signal.

Here, the optical waveguide may be formed of an optical fiber or a polymer optical waveguide film.

The optical waveguide may be installed in a printed circuit board or stacked on the printed circuit board.

The USB external apparatus may be a USB memory.

According to a third aspect of the present invention, there is provided a USB system including a USB driver apparatus of a host computer having an optical USB port, and a USB external apparatus for exchanging data with the host computer through an optical USB terminal connected to the optical USB port. The USB driver apparatus includes a first USB interface part configured to input and output data through the optical USB port, and a first photoelectric converter connected between the optical USB port and the first USB interface part to convert an optical signal into an electrical signal and vice versa. The optical USB port and the first photoelectric converter are connected to each other through an optical waveguide to transmit data as an optical signal. The USB external apparatus includes a second USB interface part configured to input and output data through the optical USB terminal, and a second photoelectric converter connected between the optical USB terminal and the second USB interface part to convert an optical signal into an electrical signal and vice versa. The optical USB terminal and the second photoelectric converter are connected to each other through an optical waveguide to transmit data as an optical signal. The USB driver apparatus and the USB external apparatus exchange data with each other through connection to the optical USB port and the optical USB terminal, and the optical waveguides are installed in the USB driver apparatus and the USB external apparatus to exchange data using an optical signal.

Here, the optical waveguide may be formed of an optical fiber or a polymer optical waveguide film.

The optical waveguide may be installed in a printed circuit board or stacked on the printed circuit board.

The optical USB port and the optical USB terminal may include guide pins and guide holes corresponding to the respective optical waveguides to optically align the optical waveguides with each other such that the optical waveguides can be optically connected to each other through coupling of the guide pins to the guide holes.

The guide pins and the guide holes may be formed of a conductive material, and the guide pins and the guide holes may be coupled to supply power to the USB driver apparatus and the USB external apparatus.

According to a fourth aspect of the present invention, there is provided a USB connection apparatus for connecting at least two different USB driver apparatuses having optical USB ports to each other, the USB connection apparatus including: at least two optical USB terminals coupled to the optical USB ports and having optical waveguides therein; and an optical waveguide cable configured to connect the optical USB terminals to each other.

Here, the optical USB port and the optical USB terminal may include guide pins and guide holes corresponding to the optical waveguides to align the optical waveguides with each other such that the optical waveguides are optically connected to each other through coupling of the guide pins to the guide holes.

The guide pins and the guide holes may be formed of a conductive material, and the guide pins and the guide holes may be coupled to each other to supply power to the USB driver apparatus and the USB external apparatus.

The optical waveguide may be formed of an optical fiber or a polymer optical waveguide film.

As can be seen from the foregoing, a USB driver apparatus using an optical waveguide, a USB external apparatus connected to the same, and a USB system including the same in accordance with the present invention are capable of transmitting data between a USB port and a first USB interface part included in the USB driver apparatus and between a USB terminal and a second USB interface part included in the USB external apparatus as an optical signal using the optical waveguide, and transmitting data between the USB driver apparatus and the USB external apparatus as an optical signal to transmit the data at a high speed.

In addition, in accordance with the present invention, two different USB driver apparatuses can be connected to each other through the optical waveguide to transmit data at a high speed as an optical signal.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a plan view of a conventional USB system for transmitting data using an electrical interconnection;

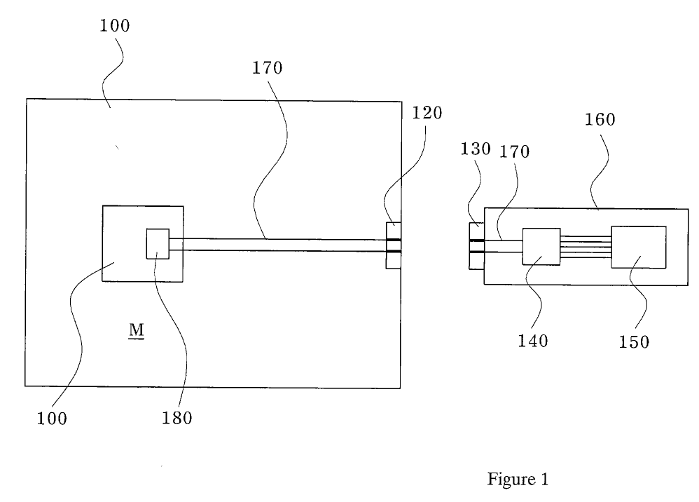

FIG. 2 is a plan view of a conventional USB system adopting an optical connection;

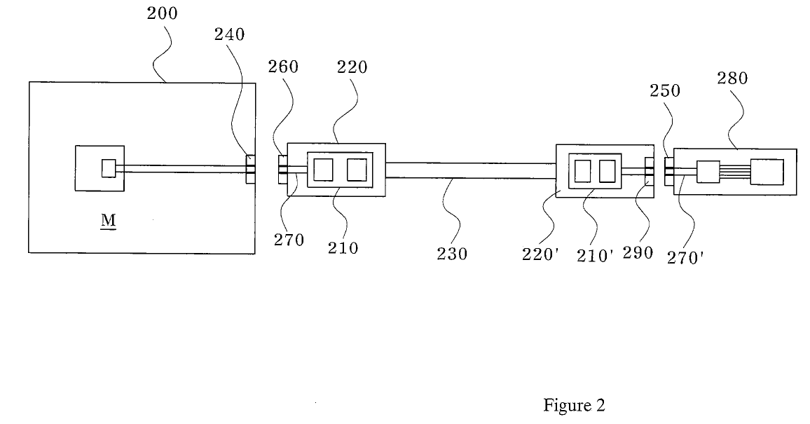

FIG. 3 is a plan view of a USB system including a USB driver apparatus and a USB external apparatus in accordance with an exemplary embodiment of the present invention;

FIG. 4 is a perspective view of a guide pin and a guide hole formed at an optical USB port and an optical USB terminal in accordance with an exemplary embodiment of the present invention; and

FIG. 5 is a plan view of a USB connection apparatus in accordance with an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art.

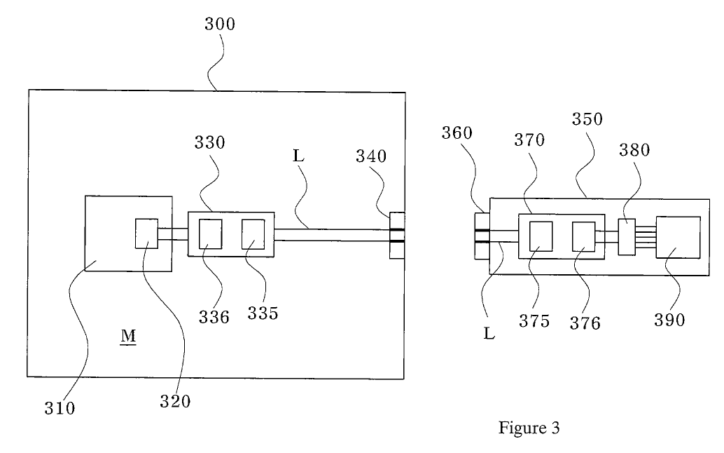

FIG. 3 is a plan view of a USB system including a USB driver apparatus and a USB external apparatus in accordance with an exemplary embodiment of the present invention. A USB memory will be described as an example of the USB external apparatus, but the USB external apparatus is not limited thereto.

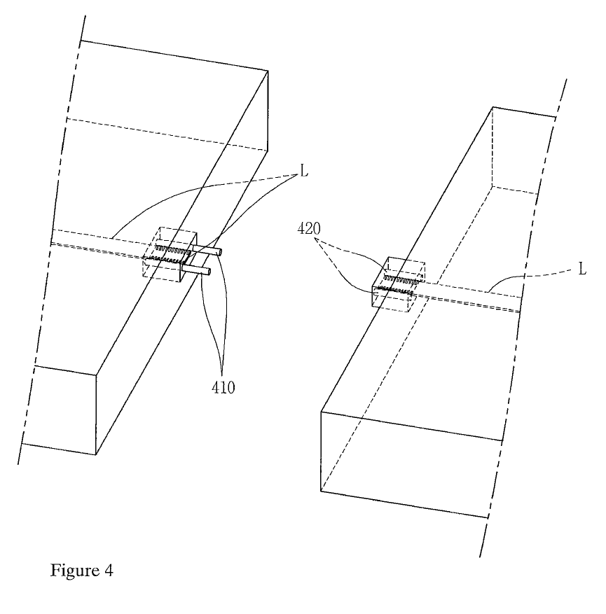

FIG. 4 is a perspective view of a guide pin and a guide hole formed at an optical USB port and an optical USB terminal in accordance with an exemplary embodiment of the present invention.

Referring to FIGS. 3 and 4, the USB system generally includes a USB driver apparatus 300, and a USB external apparatus 350.

As shown in FIG. 3, the USB driver apparatus 300 includes an I/O device 310 formed on a motherboard M of a host computer, for example, a computer device, and so on, a first USB interface part 320, a first photoelectric converter 330, and an optical USB port 340. The host computer may include all devices to which the USB driver apparatus 300 in accordance with an exemplary embodiment of the present invention can be adapted, such as a multimedia device, a peripheral device, or the like, in addition to the computer device.

The I/O device 310 is configured to include the first USB interface part 320 for inputting/outputting data through the optical USB port 340, and, for example, may be included in a bridge chip-set, a microprocessor, or the like, having a USB driver function.

The first USB interface part 320 is a circuit having a USB driver function, and functions to receive data from the USB external apparatus 350 or output data to the USB external apparatus 350 through the optical USB port 340.

The first photoelectric converter 330 is connected between the optical USB port 340 and the first USB interface part 320 to convert an optical signal into an electrical signal and vice versa. That is, data transmitted from the optical USB port 340 are converted from an optical signal into an electrical signal to be input into the first USB interface part 320, and then, data output from the first USB interface part 320 are converted from an electrical signal into an optical signal to be transmitted to the optical USB port 340.

The first photoelectric converter 330 includes, for example, an optical transmission/reception device 335 and an optical transmission/reception circuit 336. The optical transmission/reception device 335 includes a photo detector, i.e., an optical transmitting laser diode or an optical receiving photodiode to convert an optical signal into an electrical signal and vice versa. The optical transmission/reception circuit 336 uses an optical transmitting IC for operating the laser diode or an optical receiving IC for operating the photodiode to control photoelectric conversion of the optical transmission/reception device 335.

The optical USB port 340 includes an optical waveguide L installed therein to transmit data as an optical signal. A distal end of the optical waveguide L is configured to be exposed to the exterior of a host computer to be optically connected to the USB external apparatus 350, i.e., to be coupled to the optical USB terminal 360 of the USB external apparatus 350 to exchange data as an optical signal. For example, the optical USB port 340 may be an optical connector that can be detachably attached to an optical cable, and so on.

In addition, as shown in FIG. 4, the optical USB port 340 has a guide pin 410 corresponding to the optical waveguide L to be coupled to a guide hole 420 formed at the optical USB terminal 360 of the USB external apparatus 350 such that the optical waveguides L formed at the optical USB port 340 and the optical USB terminal 360 are aligned with each other. Here, the optical USB port 340 may have the guide hole 420 rather than the guide pin 410, and in this case, the optical USB terminal 360 has the guide pin 410 coupled thereto.

Here, the optical USB port 340 is connected to the first photoelectric converter 330 through the optical waveguide L to transmit data as an optical signal.

The optical waveguide L may be formed of, for example, an optical fiber or a polymer optical waveguide film. The optical waveguide L may be stacked on, for example, a printed circuit board (PCB) of a motherboard M. That is, the optical fiber or the polymer optical waveguide film is installed in the PCB or attached to the surface of the PCB in the form of film. Instead of the PCB, a polymer substrate, a semiconductor substrate, or the like, may be used.

Meanwhile, the USB external apparatus 350 in accordance with an exemplary embodiment of the present invention, for example, the USB memory, includes an optical USB terminal 360, a second photoelectric converter 370, a second USB interface part 380, and a memory chip 390.

The USB terminal 360 has the optical waveguide L formed therein to transmit data using an optical fiber. As a distal end of the optical waveguide L is exposed to the exterior, the optical USB terminal 360 is optically connected to the USB driver apparatus 300 of the host computer, i.e., connected to the optical USB port 340 of the USB driver apparatus 300, to exchange data as an optical signal. For example, the optical USB terminal 360 may be an optical connector that can be detachably attached to an optical cable, and so on.

In addition, as shown in FIG. 4, the optical USB terminal has the guide holes 420 corresponding to the optical waveguides to be coupled to the guide pins 410 formed at the optical USB port 340 of the USB driver apparatus 300 such that the optical waveguides L formed at the optical USB terminal 360 and the optical USB port 340 are aligned with each other. At this time, the optical USB terminal 360 may have the guide pin 410, rather than the guide hole 420, and in this case, the optical USB port 340 has the guide hole 420 coupled thereto.

The second photoelectric converter 370 is connected between the optical USB terminal 360 and the second USB interface part 380 to convert an optical signal into an electrical signal and vice versa. That is, data transmitted from the optical USB terminal 360 are converted from an optical signal into an electrical signal to be input into the second USB interface part 380, and then, data output from the second USB interface part 380 are converted from an electrical signal into an optical signal to be transmitted to the optical USB terminal 360.

The second photoelectric converter 370 includes, for example, an optical transmission/reception part 375 and an optical transmission/reception circuit 376. The optical transmission/reception part 375 includes a photo detector, i.e., an optical transmitting laser diode or an optical receiving photodiode to convert an optical signal into an electrical signal and vice versa. The optical transmission/reception circuit 376 uses an optical transmitting IC for operating the laser diode or an optical receiving IC for operating the photodiode to control photoelectric conversion of the optical transmission/reception device 375.

Here, the second photoelectric converter 370 and the optical USB terminal 360 are connected to each other through the optical waveguide L to transmit data as an optical signal.

The second USB interface part 380 functions to receive data from the USB driver apparatus 300 or output data to the USB driver apparatus 300 through the optical USB terminal 360.

Finally, the memory chip 390 functions to store data transmitted from the USB driver apparatus 100 of the host computer or to be transmitted to the host computer.

Meanwhile, the optical waveguide L may be formed of, for example, an optical fiber or a polymer optical waveguide film. In addition, the optical waveguide L may be stacked on the PCB formed in the USB external apparatus 350. That is, the optical waveguide may be configured to install the optical fiber or the polymer optical waveguide film in the PCB or may be attached to the surface of the PCB in the form of film. Instead of the PCB, a polymer substrate, a semiconductor substrate, or the like may be used.

As described above, the USB system including the USB driver apparatus and the USB external apparatus in accordance with an exemplary embodiment of the present invention can transmit data from the interior of the USB driver apparatus of the host computer, for example, a computer device, and so on, to the optical USB external apparatus through an optical waveguide to increase transmission speed through the interconnection to about 5 Gb/sec or more, and reduce power consumption required for signal transmission.

In addition, since the optical PCB on which the optical waveguide is stacked on the motherboard of the host computer is used, it is possible to obtain a board structure having high integrity and stability. Further, an optical connector structure optically connected between the optical USB port and the optical USB external apparatus through the guide pin and the guide hole may be used to enable precise optical alignment and obtain a readily detachable structure.

Meanwhile, the USB system including the USB driver apparatus and the USB external apparatus in accordance with an exemplary embodiment of the present invention can supply power required for operating the USB driver apparatus 300 and the USB external apparatus 350 through two power cables like the conventional USB system using an electrical interconnection. Since the power cable has the same constitution as the conventional power cable, a detailed description thereof will be omitted.

In addition, two power cables are connected between the USB driver apparatus 300 and the USB external apparatus 350 using a separate detachable electrical interconnection connector, or more preferably, as shown in FIG. 4, power may be supplied through coupling between two guide pins 410 and two guide holes 420 for optical alignment, which are formed of a conductive material such as metal.

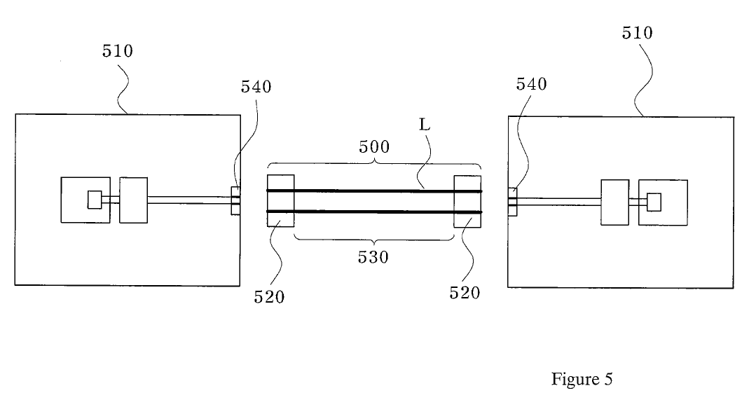

FIG. 5 is a plan view of a USB connection apparatus in accordance with an exemplary embodiment of the present invention.

Referring to FIGS. 4 and 5, the USB connection apparatus 500 in accordance with an exemplary embodiment of the present invention is a device for connecting two host computers, for example, computer devices, and so on, including USB driver apparatuses 510. The USB connection apparatus includes at least two optical USB terminals 520 and an optical waveguide cable 530. Here, the host computer is not limited to the computer device, and may include various types of devices such as multimedia devices, computer peripheral devices, or the like, in addition to the computer device.

The optical USB terminal 520 includes an optical waveguide L installed therein to transmit data as an optical signal. A distal end of the optical waveguide L is configured to be exposed to the exterior of a host computer to be optically connected to the USB driver apparatuses 510 of the host computers, i.e., to be coupled to the optical USB ports 540 of the USB driver apparatuses 510 to exchange data between the USB driver apparatuses 510 using an optical signal. For example, the optical USB terminal 520 may be an optical connector that can be detachably attached to an optical cable, and so on.

In addition, as shown in FIG. 4, the optical USB terminal 520 has a guide hole 420 corresponding to the optical waveguide L to be coupled to a guide pin 410 formed at the optical USB port 540 of the USB driver apparatus 510 such that the optical waveguides L formed at the optical USB terminal 520 and the optical USB port 540 are aligned with each other. At this time, the optical USB terminal 520 may have the guide pin 410, rather than the guide hole 420, and in this case, the optical USB port 540 has the guide hole 420 coupled thereto.

The optical waveguide cable 530 includes an optical waveguide for connecting at least two optical USB terminals. Two different host computers can transmit data to each other through the optical waveguide cable 530 using an optical signal.

Although exemplary embodiments of a USB driver apparatus using an optical waveguide, a USB external apparatus connected to the same, and a USB system and a USB connection apparatus including the same according to the present invention have been described for illustrative purposes, those skilled in the art will appreciate that various modifications, additions and substitutions are possible, without departing from the scope and spirit of the invention as disclosed in the accompanying claims.

What is claimed is:

1. A USB driver apparatus of a host computer for exchanging data with an external apparatus having a USB terminal, the USB driver apparatus comprising:
an optical USB port connected to the USB terminal of the external apparatus and configured to exchange data with the USB terminal using an optical signal;
a USB interface part configured to input and output data through the optical USB port; and
a photoelectric converter connected between the optical USB port and the USB interface part and configured to convert an optical signal into an electrical signal and vice versa,
wherein the optical USB port and the photoelectric converter are connected to each other through an optical waveguide to transmit data as an optical signal.

2. The USB driver apparatus according to claim 1, wherein the optical waveguide is formed of an optical fiber or a polymer optical waveguide film.

3. The USB driver apparatus according to claim 1, wherein the optical waveguide is installed in a printed circuit board or stacked on a printed circuit board.

4. A USB external apparatus for exchanging data with a USB driver apparatus of a terminal having a USB port, the USB external apparatus comprising:
an optical USB terminal connected to the USB port of the terminal and configured to exchange data with the USB port using an optical signal;
a USB interface part configured to input and output data through the optical USB terminal; and
a photoelectric converter connected between the optical USB terminal and the USB interface part and configured to convert an optical signal into an electrical signal and vice versa,
wherein the optical USB terminal and the photoelectric converter are connected to each other through the optical waveguide to transmit data as an optical signal.

5. The USB external apparatus according to claim 4, wherein the optical waveguide is formed of an optical fiber or a polymer optical waveguide film.

6. The USB external apparatus according to 4, wherein the optical waveguide is installed in a printed circuit board or stacked on a printed circuit board.

7. The USB external apparatus according to claim 4, wherein the USB external apparatus is a USB memory.

8. A USB system including a USB driver apparatus of a host computer having an optical USB port, and a USB external apparatus for exchanging data with the host computer through an optical USB terminal connected to the optical USB port,
wherein the USB driver apparatus comprises a first USB interface part configured to input and output data through the optical USB port, and a first photoelectric converter connected between the optical USB port and the first USB interface part to convert an optical signal into an electrical signal and vice versa, the optical USB port and the first photoelectric converter being connected to each other through an optical waveguide to transmit data as an optical signal,
the USB external apparatus comprises a second USB interface part configured to input and output data through the optical USB terminal, and a second photoelectric converter connected between the optical USB terminal and the second USB interface part to convert an optical signal into an electrical signal and vice versa, the optical USB terminal and the second photoelectric converter being connected to each other through an optical waveguide to transmit data as an optical signal, and
the USB driver apparatus and the USB external apparatus exchange data with each other through connection to the optical USB port and the optical USB terminal, and the optical waveguides are installed in the USB driver apparatus and the USB external apparatus to exchange data using an optical signal.

9. The USB system according to claim 8, wherein the optical waveguide is formed of an optical fiber or a polymer optical waveguide film.

10. The USB system according to claim 8, wherein the optical waveguide is installed in a printed circuit board or stacked on a printed circuit board.

11. The USB system according to claim 8, wherein the optical USB port and the optical USB terminal comprise guide pins and guide holes corresponding to the respective optical waveguides to optically align the optical waveguides with each other such that the optical waveguides can be optically connected to each other through coupling of the guide pins to the guide holes.

12. The USB system according to claim 11, wherein the guide pins and the guide holes are formed of a conductive material and coupled to each other to supply power to the USB driver apparatus and the USB external apparatus.

13. A USB connection apparatus for connecting at least two different USB driver apparatuses having optical USB ports to each other, the USB connection apparatus including:
at least two optical USB terminals coupled to the optical USB ports and having optical waveguides therein; and
an optical waveguide cable configured to connect the optical USB terminals to each other.

14. The USB connection apparatus according to claim 13, wherein the optical USB port and the optical USB terminal comprise guide pins and guide holes corresponding to the optical waveguides to align the optical waveguides with each other such that the optical waveguides are optically connected to each other through coupling of the guide pins to the guide holes.

15. The USB connection apparatus according to claim 14, wherein the guide pins and the guide holes are formed of a conductive material and coupled to each other to supply power to the USB driver apparatus and the USB external apparatus.

16. The USB connection apparatus according to claim 13, wherein the optical waveguide is formed of an optical fiber or a polymer optical waveguide film.
